(19) United States
(12) Patent Application Publication
(10) Pub. No.: US 2010/0122134 A1
(43) Pub. Date: May 13, 2010

(54) APPLICATION-CONFIGURED, CONTENT-BASED RETRANSMISSION SCHEME FOR DROPPED MEDIA ACCESS CONTROL FRAMES

(75) Inventors: FAWAD SHAUKAT, San Diego, CA (US); Samir S. Soliman, San Diego, CA (US); Krishman Rajamani, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/268,150

(22) Filed: Nov. 10, 2008

(51) Int. Cl. H04L 1/18; G06F 11/00

(52) U.S. Cl. 714/748; 714/E11.001

(57) ABSTRACT

In a generic Media Access Control (MAC) protocol, the retransmission of a dropped MAC frame is independent of the payload. Methods, systems, and computer products defining a mechanism of retransmission of one or more frames based on content of the payload are provided. The system identifies the content as text or video and retransmits if the content is text. The one or more frames may be retransmitted using a specific retransmission scheme. The retransmission is checked again to determine if it is was dropped, and transmitted again if it was dropped.

### FIELD OF THE INVENTION

The present methods and apparatus relate generally to communication systems, and more specifically to transmitting one or more media access control (MAC) frames based on a payload content associated with the one or more frames.

### BACKGROUND

In the prior art or generic MAC protocol systems, retransmission of a lost or dropped frame is independent of the payload. Thus, all of the lost frames are retransmitted. This adversely affects the performance of the system. Since the bandwidth available in a wireless network is usually limited, it is imperative to avoid any unnecessary retransmissions that consume part of the available bandwidth, which could otherwise be used for useful transmissions. The problem occurs when a retransmission is needed due to a dropped MAC frame over the air, and the MAC layer does not know if a retransmission will help or not. Retransmitting the same MAC frame without the knowledge of the payload may result in decreased performance. Failure to retransmit without the knowledge of the payload may result in a lack of data integrity. Accordingly, improved methods and apparatus for transmitting data (e.g., text and video) over a wireless network are desired.

### SUMMARY

Aspects disclosed herein address the above-stated needs by selectively retransmitting one or more lost or dropped frames depending on the payload data associated with the one or more frames. In case of video transmission, if one of the MAC frames that is part of a complete video frame is lost, retransmitting that frame becomes too much of an overhead for very little use. Also, the flow of the displayed video content gets affected. If the MAC layer informs the upper layer which MAC frame was lost, then in the next video frame, (that may be a partial video frame) the application will include that particular portion to complete the picture on the display. In case of text transmission, if one of the MAC frames that is part of a slide in a presentation is lost, retransmission of that frame is necessary to avoid any part of the slide being void of important text that is to be displayed to the audience.

In a first aspect, methods and apparatus are provided for determining the type of content that needs to retransmit a lost frame. If it is text in nature, then the application layer instructs the MAC layer to retransmit a lost frame, whereas in case of the content type being video in nature, the application layer instructs the MAC layer to not retransmit a lost frame and report back the sequence number of the frame that was lost. The MAC layer employs a retransmission scheme based on the instruction by the application layer and decides whether to retransmit a dropped frame or not based on the retransmission scheme. If retransmission does happen, then the MAC layer may inform the application layer about the dropped MAC frame, so the application can take necessary steps.

The present methods and apparatus may increase overall throughput, increase data integrity of text content, and enhance visual effects of video content. The methods and apparatus retransmit a lost MAC frame only when it is needed based on the content of the payload of the lost MAC frame. The selective retransmission will in turn increase the overall throughput, eliminate any discrepancies in text content such that the text is easily readable to the audience, and enhance the visual effects of video content by not letting the flow of the video stream to be affected by unnecessary retransmissions.

### BRIEF DESCRIPTION OF THE DRAWINGS

FIG. 1 is a flow chart showing the process in the application layer in accordance with an aspect.

FIG. 2 is a flow chart showing the process in the MAC layer in accordance with an aspect.

FIG. 3 shows a typical hardware configuration in accordance with an aspect.

### DETAILED DESCRIPTION

### Definitions

The word “exemplary” is used herein to mean “serving as an example, instance, or illustration.” Any aspect described herein as “exemplary” is not necessarily to be construed as preferred or advantageous over other aspects. The phrase “video frame” is defined as a collection of pixels that displays a snapshot in any instance of time. The phrase “MAC frame” is defined as a set of bits (0,1) that makes a packet of information corresponding to the data link layer in the OSI model. The words packet and frame have been interchangeably used in the description.

Although the description refers to a wireless system, the claimed invention is intended to also be utilized in all types of communication systems, including wired systems.

The present methods and apparatus may or may not retransmit a dropped MAC frame based on the type of content (e.g., of payload data) that is being transmitted. This helps in avoiding any use of the available bandwidth for unnecessary transmissions. Also, it avoids data integrity problems on the client (e.g., receiver) side by retransmitting the frame when loss of data is unacceptable.

The MAC layer needs to be configured for retransmission by the upper layer based on what type of content will be transmitted. The retransmission of a MAC frame depends on a number of physical layer (PHY) and MAC layer parameters; some of which are throughput desired, latency acceptable by the upper layer, as well as other factors. Thus, a MAC frame retransmission is a function of certain PHY and MAC layer parameters.

The present methods and apparatus may require the MAC layer to provide primitives to the application layer to configure the parameters that set the retransmission. For the three parameters described above, the following primitives are provided by the MAC layer:
MLME-SET_TPUT.request (tput)
MLME-SET_TPUT.confirm (ResultCode)
MLME-SET_LATENCY.request (latency)
MLME-SET_LATENCY.confirm (ResultCode)
   Similar primitives are required for any other parameters that determine retransmission. The steps that are needed to implement the present methods and apparatus require a collaborative effort from both the application layer and the MAC layer. In the present patent application, the throughput needed and the maximum latency are defined as parameters and MLME-SET_TPUT and MLME-SET_LATENCY are defined as primitives. The primitives are used to set parameters.

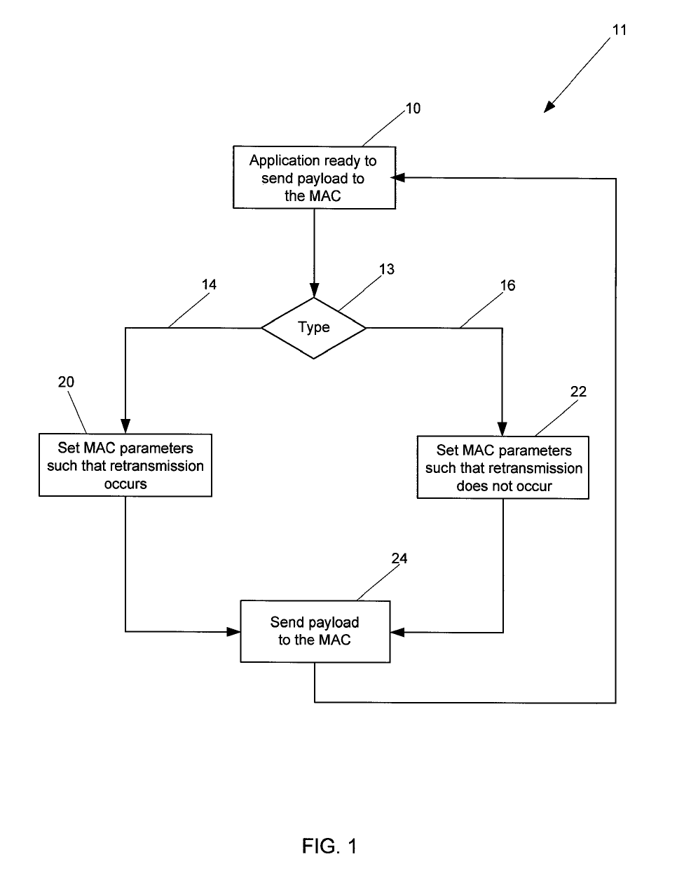

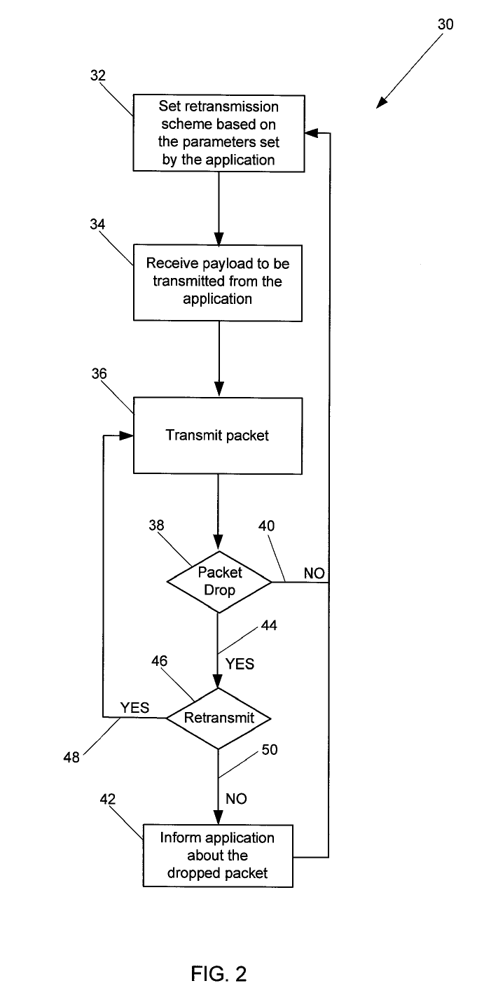

FIG. 1 is a flowchart 10 showing the process in the application layer 11 in accordance with an aspect. For the present methods and apparatus, the application layer 11 may detect the type of content being transmitted. It also contributes in configuring the MAC layer for retransmissions based on the type of content being transmitted. When application layer 11 is ready to send data to the MAC layer for transmission 12, it needs to decide the type of data 13, in this case whether the payload is text 14 or video 16 in nature. If the payload is text 14 in nature, application layer 11 uses the primitives provided by MAC layer 30 (FIG. 2) to set certain parameters such that a dropped MAC frame is retransmitted 20 (e.g., configure a first retransmission scheme). In case of the payload being video 16 in nature, the application layer sets the parameters such that a dropped MAC frame is not retransmitted 22 (e.g., configure a second retransmission scheme). Once the retransmission scheme is decided, application layer 11 sends the payload to the MAC layer for transmission 24.

FIG. 2 is a flowchart showing the process steps of MAC layer 30 in accordance with an aspect. The contribution at the MAC layer 30 for the present methods and apparatus involves providing primitives to set parameters that determine the retransmission scheme to the application layer 11. It also contributes in providing information to the application layer 11 about a dropped MAC frame. First, set the retransmission scheme 32 that is determined by the values of the parameters set by application layer 11. Next, MAC layer 30 receives the payload from the application layer to be transmitted 34. Transmit the packet 36 or MAC frame encapsulating the payload to the destination. A check is made of whether the frame is dropped 38 during transmission. If the packet is not dropped 40, application layer 11 may be informed 42 of the successful transmission, and the next application packet may begin the process again at step 32. If the packet is dropped 44, a determination is made whether a retransmission is needed 46. If a retransmission is needed 48, then retransmit the same packet 36 again. If retransmission is not needed 50, then information about the dropped frame is reported to application layer 42.

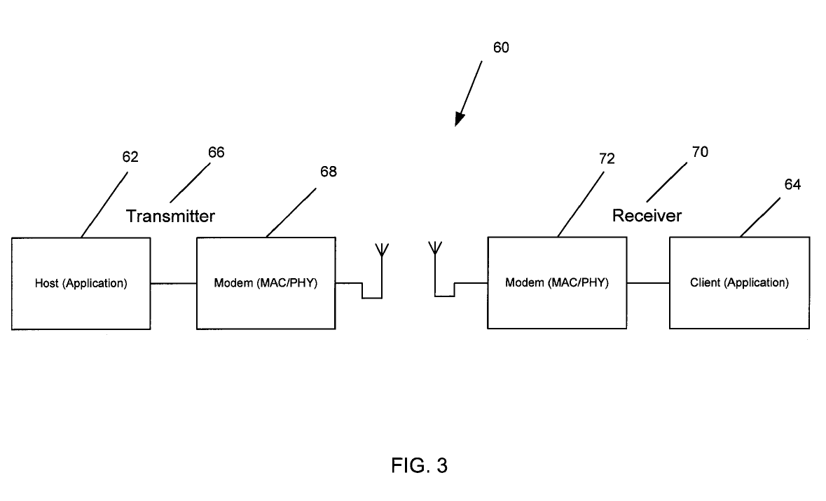

Examples of video content and text content being transmitted over wireless Mobile Display Digital Interface (MDDI) 60 from a host device 62 to a client device 64 are provided in FIG. 3, to explain the aspects of the present methods and apparatus. Host device 62, in this application a transmitter 66, is electrically connected to a modem 68 for transmission of the MAC frames. Client device 64, in this application a receiver 70, is electrically connected to modem 72 for receipt of the transmitted MAC frames. In some aspects, host device 62 may include may one or more processors and one or more memories. Client device 64 may be configured in a similar manner.

In a sequence of video frames ( . . . , n−1, n, n+1, . . . ), if frame n−1 loses one line of pixels while being transmitted, then in a regular MAC implementation, the dropped MAC frame will be retransmitted. This will create a pause effect in the video that is being displayed as no more MAC frames will be transmitted until the dropped frame is successfully transmitted. According to the present methods and apparatus, the MAC layer, after detecting a dropped MAC frame will inform the application about the MAC frame that was dropped so the application in its next frame (n) makes sure to send the portion that was dropped. This will not only reduce the bandwidth used, but will also make the visual effects of the video better as the flow of video will not be disrupted because of unnecessary retransmissions. In this case we set the MAC parameters such that retransmission does not happen so the flow of the video is not affected.

Another example of it is a PowerPoint® presentation being displayed on a projector over wireless MDDI. In a similar scenario as above, if a video frame that contains a slide from a PowerPoint® presentation is being transmitted and a line of pixels is dropped, then the retransmission of that MAC frame will be necessary because it contains information that needs to be seen by the audience for a considerable amount of time, and certain data from the slide will be missing. If the MAC frame is not retransmitted, then the application will possibly lose essential data to be shown by the presenter. In this case, the MAC parameters are set such that retransmission does happen so no necessary data is lost.

The two examples above show the importance of MAC retransmissions driven by the application. In the case of video data (e.g., a movie), retransmission will affect the flow of the video, whereas in the case of text data (e.g., a PowerPoint® presentation) no retransmissions will cause important information to be lost from the display. The present methods and apparatus may enable a single video application transmitting a single video flow to treat some packets in the same flow differently, based on the scene content/context.

The selective retransmission described above will in turn increase the overall throughput, eliminate any discrepancies in text content, such that the text is easily readable to the audience, and enhance the visual effects of video content by not letting the flow of the video stream to be affected by unnecessary retransmissions.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the presently claimed invention.

The various illustrative logical blocks, modules, and circuits described in connection with the aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor, such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the presently claimed invention. Various modifications to these aspects will be readily apparent to those skilled in the art, and the generic principles defined herein may be applied to other aspects without departing from the spirit or scope of the claimed invention. Thus, the presently claimed invention is not intended to be limited to the aspects shown herein, but is to be accorded the widest scope consistent with the principles and novel features disclosed herein.

The claimed invention is:

1. A method for transmitting at least one media access control (MAC) frame based on a payload content comprising:
a) determining whether the payload content that is being transmitted comprises a video content or a text content by an application layer;
b) configuring by the application layer of a first MAC frame retransmission scheme if the payload content comprises the text content;
c) configuring by the application layer of a second MAC frame retransmission scheme if the payload content comprises the video content; and
d) processing of the at least one MAC frame based on the configured MAC frame retransmission scheme.

2. The method of claim 1 wherein processing of the at least one MAC frame based on the configured MAC frame retransmission scheme includes retransmitting the selected at least one MAC frame by the MAC layer.

3. The method of claim 1 wherein processing of the at least one MAC frame based on the configured MAC frame retransmission scheme includes:
informing the application layer of the at least one dropped MAC frame; and
sending by the application layer of one or more portions of the at least one dropped MAC frame as part of a subsequently-transmitted MAC frame.

4. The method of claim 3 wherein the step of informing comprises identifying the video content of the at least one dropped MAC frame.

5. The method of claim 1 wherein:
configuring by the application layer of a first MAC frame retransmission scheme comprises determining values for a first set of parameters; and
configuring by the application layer of a second MAC frame retransmission scheme comprises determining values for a second set of parameters.

6. The method of claim 5 wherein the parameters comprise at least one member from the group consisting of throughput and latency.

7. The method of claim 2 further comprising:
determining whether the selected retransmitted at least one MAC frame was dropped; and
transmitting the selected retransmitted at least one MAC frame again.

8. A system for transmitting at least one media access control (MAC) frame based on a payload content comprising:
a processor;
means for determining whether the payload content that is being transmitted comprises a video content or a text content by an application layer coupled to the processor;
means for configuring by the application layer of a first MAC frame retransmission scheme if the payload content comprises the text content coupled to the processor;
means for configuring by the application layer of a second MAC frame retransmission scheme if the payload content comprises the video content coupled to the processor; and
means for processing of the at least one MAC frame based on the configured MAC frame retransmission scheme coupled to the processor.

9. The system of claim 8 wherein the means for processing of the at least one MAC frame based on the configured MAC frame retransmission scheme includes means for retransmitting the selected at least one MAC frame by the MAC layer.

10. The system of claim 8 wherein the means for processing of the at least one MAC frame based on the configured MAC frame retransmission scheme includes:
means for informing the application layer of the at least one dropped MAC frame; and
means for sending by the application layer of one or more portions of the at least one dropped MAC frame as part of a subsequently-transmitted MAC frame.

11. The system of claim 10 wherein the means for informing comprises identifying the video content of the at least one dropped MAC frame.

12. The system of claim 8 wherein:
the means for configuring by the application layer of a first MAC frame retransmission scheme includes a means for determining values for a first set of parameters; and
the means for configuring by the application layer of a second MAC frame retransmission scheme includes a means for determining values for a second set of parameters.

13. The system of claim 12 wherein the parameters comprise at least one member from the group consisting of a throughput and a latency.

14. The system of claim 9 further comprising:
means for determining whether the selected retransmitted at least one MAC frame was dropped; and
means for transmitting the selected retransmitted at least one MAC frame again.

15. The system of claim 8 further comprising a device coupled to the processor for receiving the at least one MAC frame.

16. A computer product comprising:
computer-readable medium comprising:
one or more instructions for causing a computer to transmit at least one media access control (MAC) frame based on a payload content comprising:
at least one instruction for causing a computer to determine whether the payload content that is being transmitted comprises a video content or a text content by an application layer;
at least one instruction for causing a computer to configure by the application layer of a first MAC frame retransmission scheme if the payload content comprises the text content;
at least one instruction for causing a computer to configure by the application layer of a second MAC frame retransmission scheme if the payload content comprises the video content; and
at least one instruction for causing a computer to process the at least one MAC frame based on the configured MAC frame retransmission scheme.

17. The computer product of claim 16 further comprising at least one instruction for causing a computer to retransmit the selected at least one MAC frame by the MAC layer.

18. The computer product of claim 16 further comprising:
at least one instruction for causing a computer to inform the application layer of the at least one dropped MAC frame; and
at least one instruction for causing a computer to send by the application layer of one or more portions of the at least one dropped MAC frame as part of a subsequently-transmitted MAC frame.

19. The computer product of claim 18 further comprising at least one instruction for causing a computer to identify the video content of the at least one dropped MAC frame.

20. The computer product of claim 16 further comprising:
at least one instruction for causing a computer to determine values for a first set of parameters; and
at least one instruction for causing a computer to determine values for a second set of parameters.

21. The computer product of claim 17 further comprising:
at least one instruction for causing a computer to determine whether the selected retransmitted at least one MAC frame was dropped; and
at least one instruction for causing a computer to transmit the selected retransmitted at least one MAC frame again.
